(19) United States
(12) Patent Application Publication
(10) Pub. No.: US 2005/0097747 A1
(43) Pub. Date: May 12, 2005

(54) Method for fabricating a heat-dissipating tube by use of heating process for air expulsion

(76) Inventor: Pao-Shu Hsieh, ChungHo City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,622

(22) Filed: Nov. 12, 2003

(51) Int. Cl. B23Q 17/00; G01M 19/00

(52) U.S. Cl. 29/890.045; 29/407.08

(57) ABSTRACT

The invention relates to a method for fabricating a heat-dissipating tube by use of heating process for air expulsion. The method includes the steps of: weighing the empty tube; feeding a little more pure water than the working amount into the tube; compressing an water inlet to form a semicircular member in a not completely closed state; heating the tube for changing the pure water into vapor for air expulsion; compressing the semicircular member in a fully sealed state; keeping the tube warm and maintaining the tube pressure; spot-welding the top of the semicircular member with a sealing layer; weighing the finished product; and determining the weight difference for finding the actual input amount of water after the process of air expulsion by heating and for judging if the tube is a conforming or a nonconforming item.

### BACKGROUND OF THE INVENTION

1. Field of the Invention

The invention relates to a method for fabricating a heat-dissipating tube by use of heating process for air expulsion, and more particularly, to a method in which the water inlet is completely sealed by use of two-step compression. Moreover, the nonconforming items can be removed by the difference of weight measured before and after the processing.

2. Description of the Related Art

Heat-dissipating tubes are indispendable components for a notebook computer. Due to the tendency of more and more compact configuration of the notebook computer, the heat-dissipating tubes must have a corresponding cooling efficiency under the restriction of limited space in the notebook. Therefore, the quality thereof is very demanding.

TW 221794 discloses a “method for fabricating a tube whose end is sealed by way of screwing and heating for air-expulsion”. The disclosure lies in the screwing action of the screwing tool for completely sealing the feeding mouth. Although it's possible to utilize the metal ductility to close the feeding mouth, the metal elasticity and the processing precision could result in an incomplete closure of the feeding mouth. Thus, the product quality could be instable.

TW 153725 discloses a “method for fabricating a heat-dissipating tube and device for feeding in a quantitative way. In this disclosure, it's possible to read the amount of condensate from the scale of the collecting bottle for determining the moment when to seal the feeding tube. However, the amount of the working liquid is extremely slight so that it is difficult to determine an optimal moment for sealing the tube. Thus, this will also lead to the problem of nonconforming quality due to the inconsistent amount of working liquid to be fed.

### SUMMARY OF THE INVENTION

It is a primary object of the invention to eliminate the above-mentioned problems and provide a method for fabricating a heat-dissipating tube by use of heating process for air expulsion so as to the product quality.

It is another object of the invention to provide a method for fabricating a heat-dissipating tube by use of heating process for air expulsion, wherein the water inlet is completely sealed by use of two-step compression, and wherein the nonconforming items can be removed by the difference of weight measured before and after the processing.

It is a further object of the invention to provide a method for fabricating a heat-dissipating tube by use of heating process for air expulsion wherein the conforming rate of products can be raised.

### BRIEF DESCRIPTION OF THE DRAWINGS

The accomplishment of this and other objects of the invention will become apparent from the following descriptions and its accompanying drawings of which:

FIG. 1 is a flow chart of fabricating process in accordance with the invention; and

FIGS. 2A through 2D are perspective views of a tube in different processing steps.

### DETAILED DESCRIPTION OF THE PREFERRED EMBODIMENT

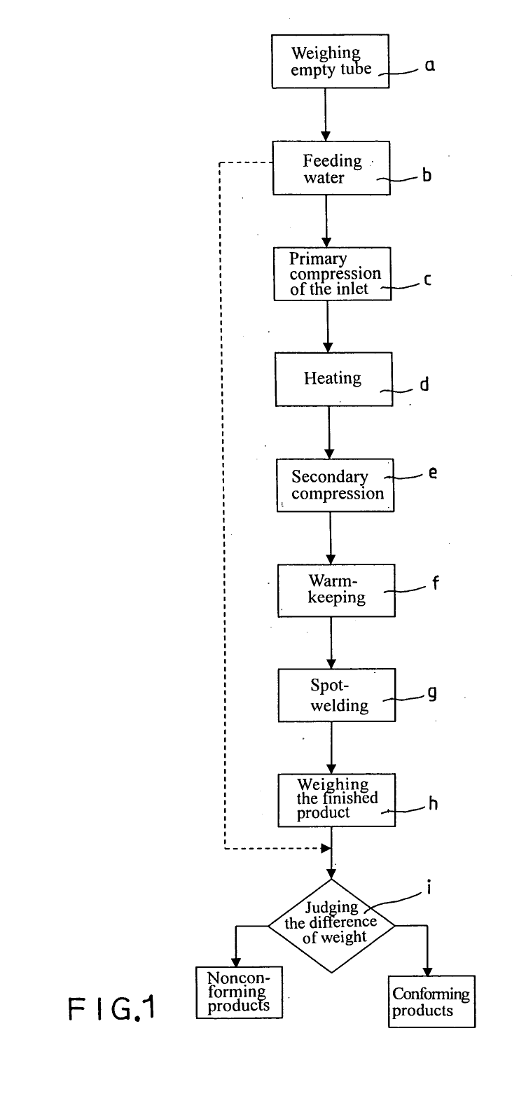

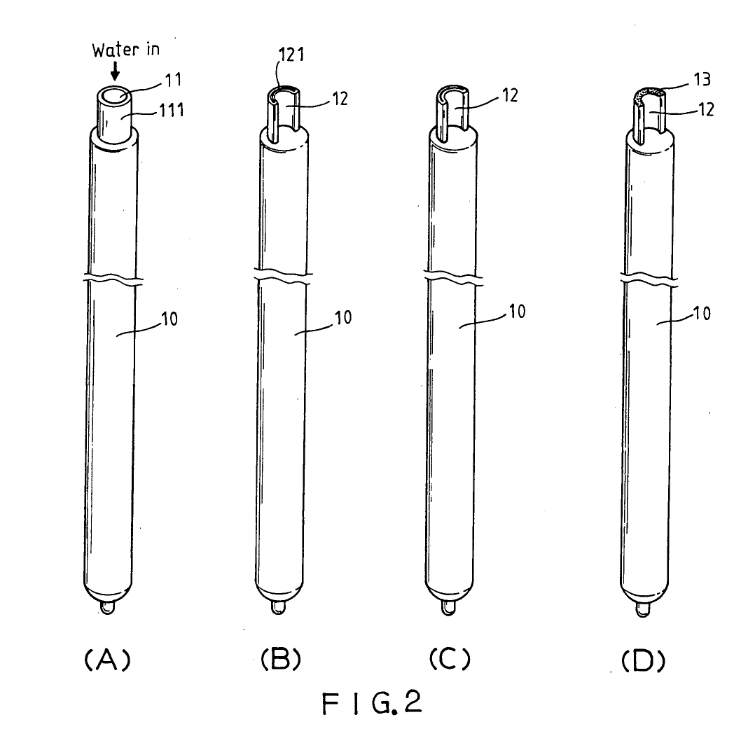

As shown in FIG. 1, the method in accordance with the invention comprising the steps of:
a) weighing the empty tube 10, as shown in FIG. 2A with an electronic scale for finding the actual weight of the tube 10 in empty state;
b) feeding a little more pure water than the working amount into a water inlet 11 of a neck 111 at the distal end of the tube, as shown in FIG. 2A, wherein the diameter of the neck 111 is smaller than that of the tube 10 for facilitating the execution of next step;
c) compressing the half part of the neck 111 to another part thereof for forming a semicircular member 12 with a tiny gap 121 at the top of the neck 111, as shown in FIG. 2B, for raising the efficiency of air expulsion by use of heating process;
d) heating the tube 10 for vaporizing the pure water such that the vapor is filled in the tube 10 and the air in the tube 10 is expelled by the vapor through the gap 121 to the outside, wherein the heating duration and temperature is dependent on the size of the tube to optimize the air expulsion, and wherein the gap 121 is much minimized for preventing vapor from dissipation;
e) compressing the semicircular member 12 in a fully sealed state, as shown in FIG. 2C, to remove the gap 121, wherein the semicircular shape of the member 12 enables, on the one hand, an efficient control in forming the gap 121 in the c)-step and, on the other hand, a better mechanical strength in this step;
f) keeping the tube 10 warm and maintaining the pressure within the tube for preventing the air from flowing back into the tube 10;
g) spot-welding the top of the semicircular member 12 with a sealing layer 13, as shown in FIG. 2D, for ensuring a complete leakproofness of the semicircular member 12;
h) weighing the finished product for finding the total weight of the tube and the pure water; and
i) determining the weight difference by subtracting the weight of empty tube from the weight of the finished product for finding the actual input amount of water after the process of air expulsion by heating and for judging if the tube is a conforming or a nonconforming item.

Based on the above-mentioned method, the invention utilizes two-step compression of the neck of the tube in a fully sealed state. Thereafter, to spot-weld the top of the semicircular member 12 with a sealing layer 13 ensures a complete leakproofness of the semicircular member 12. Moreover, a vacuum within the tube created after the process of air expulsion by heating enables an increase in heat exchange efficiency. At last, to weigh the tube of the a) and h) steps will find the actual input amount of water within the tube and check if it corresponds to the working amount. The tube will be regarded as nonconforming item when the weight difference is more or less than the weight of the working amount.

Moreover, the method of the invention can be applied to the automation machines, including tube-conveying devices, weighing device, water-feeding devices, devices for primary compression, heating devices, devices for secondary compression, warm keeping equipment and spot-welding devices. These all belong to the prior art so that no further descriptions are given hereinafter.

In comparison with the conventional method only with 80% of conformity rate, the conformity of the product fabricated by the method in accordance with the invention is considerably raised to 95% during the experiment stage. After correction, the conformity rate is expected to reach up to 98%. Consequently, the product quality can be ensured by the method of the invention.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. A method for fabricating a heat-dissipating tube by use of heating process for air expulsion comprising:
a) weighing the empty tube for finding and recording the actual weight of each tube in empty state;
b) feeding a little more pure water than the working amount into the tube;
c) compressing a water inlet to form a semicircular member in a not completely closed state;
d) heating the tube for vaporizing the pure water such that the vapor is filled in the tube and the air in the tube is expelled by the vapor through the gap to the outside;
e) compressing the semicircular member in a fully sealed state;
f) keeping the tube warm and maintaining the pressure within the tube;
g) spot-welding the top of the semicircular member with a sealing layer for ensuring a complete leakproofness of the semicircular member;
h) weighing the finished product for finding the total weight of the tube and the pure water; and
i) determining the weight difference by subtracting the weight of empty tube from the weight of the finished product for finding the actual input amount of water after the process of air expulsion by heating and for judging if the tube is a conforming or a nonconforming item.

2. The method as recited in claim 1 wherein the water inlet has a smaller diameter than that of the tube.

3. The method as recited in claim 1
